(19) United States
(12) Patent Application Publication
(10) Pub. No.: US 2014/0261792 A1
(43) Pub. Date: Sep. 18, 2014

(54) REGULATING VALVE OPENING CONTROLLING SYSTEM

(71) Applicant: Azbil Corporation, Tokyo (JP)

(72) Inventor: Tomomi OGATA, Tokyo (JP)

(73) Assignee: AZBIL CORPORATION, Tokyo (JP)

(21) Appl. No.: 14/211,160

(22) Filed: Mar. 14, 2014

(30) Foreign Application Priority Data
Mar. 14, 2013 (JP) 2013-051417

(51) Int. Cl. F16K 37/00

(52) U.S. Cl. CPC F16K 37/00
USPC 137/551

(57) ABSTRACT

A regulating valve opening controlling system includes a regulating valve characteristic information database that stores characteristic information of each individual regulating valve, in relation to a model number of each individual regulating valve, a regulating valve model number information storage portion that stores model number information of the regulating valve, a regulating valve model number information reading portion that reads the model number information of the regulating valve, a regulating valve characteristic information acquiring portion that acquires, from the regulating valve characteristic information database, characteristic information corresponding to the model number information of the regulating valve, which has been read out by the regulating valve model number information reading portion, and an information converting/setting portion that converts into specific information, and sets in the positioner, characteristic information of the regulating valve, which has been acquired by the regulating valve characteristic information acquiring portion.

### CROSS REFERENCE TO RELATED APPLICATION

This application claims priority under 35 U.S.C. §119 to Japanese Patent Application No. 2013-051417, filed on Mar. 14, 2013, the entire content of which being hereby incorporated herein by reference.

### FIELD OF TECHNOLOGY

The present invention relates to a regulating valve opening controlling system that is structured from a regulating valve and a positioner that is installed in the regulating valve.

### BACKGROUND

Conventionally, in this type of regulating valve opening controlling system, a positioner is installed in the regulating valve to control the opening of the valve within the regulating valve. In a regulating valve opening controlling system, the regulating valve has a valve and an actuator for driving the valve, where the positioner controls the opening of the valve by applying, to the actuator, a pneumatic pressure that depends on the difference between the actual valve opening and a setting for the opening.

In such a regulating valve opening controlling system, the regulating valve and the positioner are used in combination, but often they are independent devices, rather than being integrated together as a single unit. Within the positioner functions, there are those that require characteristic information, such as the regulating valve specifications, regarding the regulating valve that is used in combination, and in recent years there has been an expansion also in the characteristic information required for a regulating valve, accompanying increased functionality of the positioner functions, such as fault diagnostics.

For example, in the positioner (valve positioner) disclosed in Japanese Unexamined Patent Application Publication No. 2001-142505 (“the JP '505”, issued as Japanese Patent No. 3724289), it is possible to manually input, into the positioner, specification data for the regulating valve that is to be combined therewith (for example, valve capacity, valve spring range, valve hysteresis, and supply voltage to the actuator) as characteristic information of the regulating valve, through a man-machine interface such as a keyboard or buttons.

In this case, the positioner uses the specification data (the characteristic information) for the regulating valve that has been inputted through the man-machine interface to read out, from a database, control parameters corresponding to the specification data, to set them in the valve controlling/calculating portion. For example, values for control parameters used in controlling the opening of the valve, such as the proportional gain, the integrating time, the differentiating time, and the like, are read out from the database and loaded into the valve controlling/calculating portion.

Often the regulating valve and the positioner are purchased from different vendors, so usually at shipping there is no data in the positioner as to the regulating valve with which it is to be combined. Because of this, when shipping the positioner, it is difficult to obtain the characteristic information of the regulating valve and difficult to set up in advance, in the positioner, the parameter values corresponding to that characteristic information. It is for this reason that, in the JP '505, specification data for the regulating valve (characteristic information) is inputted manually into the positioner at the point in time wherein the regulating valve and the positioner are combined.

As described above, in Patent the JP '505, the characteristic information of the regulating valve is inputted into the positioner through a man-machine interface, such as a keyboard, buttons, or the like. For example, a mobile data reader is used to manually input characteristic information of each individual regulating valve. Because of this, the operation for inputting the characteristic information of the regulating valves is complex and extremely time-consuming.

An instrument controlling system, or the like, can also be used to input the characteristic information of the regulating valves into the positioners. However, there is still a problem in that, in many cases, the inputting is time-consuming because often, even when an instrument controlling system is used, it is not possible to perform the setup as a group, because there are various different characteristic information of the regulating valves, and because the characteristic information that is required regarding the regulating valves differs depending on the positioner (the type and model).

Even if there were a database for managing characteristic information of many different regulating valves as a group, still it would not be possible to link the positioners and the regulating valves together in the instrument controlling system, or the like. Consequently, this does not change the fact that there is the work of having to reference, from the instrument information, the characteristic information of the regulating valve that is combined with each individual positioner, and the fact that the operation for inputting this information is time-consuming.

Moreover, it is not just that it is time-consuming, but rather there is the potential for human error as well, because the operations for checking the regulating valve that is to be combined (Arrow (1) shown in FIG. 9)), reading out, from the database, the characteristic information of the regulating valve that has been checked (Arrow (2) shown in FIG. 9), and inputting, into the positioner, the characteristic information that has been read out for the regulating valve (Arrow (3) shown in FIG. 9) are all performed manually.

The present invention was created in order to solve such a problem, and an aspect thereof is to provide a regulating valve opening controlling system able to reduce the amount of labor in the operation for inputting the characteristic information of the regulating valves into the positioners, and also to able to reduce the likelihood of a human error.

### SUMMARY

In order to solve the problem set forth above, the present invention is a regulating valve opening controlling system includes: a regulating valve having a valve wherein a passage through which a fluid flows is opened and closed and an actuator that receives a pneumatic pressure and drives the valve; and a positioner, provided with the regulating valve, which controls the opening of the valve by applying, to the actuator, a pneumatic pressure that depends on a difference between the actual opening of the valve and an opening setting. The regulating valve opening controlling system further includes: a regulating valve characteristic information database that stores, for regulating valves of a plurality of different model numbers, characteristic information of each individual regulating valve, in relation to the model number of each individual regulating valve; a regulating valve model number information storage portion that stores model number information of the regulating valve, provided readably in the regulating valve; a regulating valve model number information reading portion that reads the model number information of the regulating valve, which is stored in the regulating valve model number information storage portion; a regulating valve characteristic information acquiring portion that acquires, from the regulating valve characteristic information database, characteristic information corresponding to the model number information of the regulating valve, which has been read out by the regulating valve model number information reading portion; and an information converting/setting portion that converts into specific information, and sets in the positioner, characteristic information of the regulating valve, which has been acquired by the regulating valve characteristic information acquiring portion.

Heretofore, regulating valves have not had means for generating information about themselves. Conventionally, an operation is performed wherein the regulating valve that is to be combined with the positioner is checked, and then a document, database, or the like is referenced in relation thereto, and the characteristic information of the regulating valve is inputted manually into the positioner. The type of characteristic information that is required for the regulating valve depends on the positioner, and because the positioner itself is able to detect the parameter that is the hysteresis of the regulating valve (referencing, for example, Patent Citation 2), heretofore it is not been envisioned to have the regulating valve have the information. See, for example, Japanese Unexamined Patent Application Publication No. H11-166655 (“the JP '655”, issued as Japanese Patent No. 3511458).

However, because there are not only many different types of regulating valves, but also a variety of customized components are used, there is a great deal of variation in the characteristic information of the regulating valve that must be inputted into the positioner. Moreover, if there is a change in the combination between the regulator and the positioner, due to, for example, a fault or a modification to a manufacturing line, after the plant has started up and operations have commenced, then it becomes necessary to reinput the characteristic information of the regulating valve.

The inventor in the present application focused on efficiency, including the entire lifecycle of such a regulating valve, and contemplated that if it were possible to read out model number information of a regulating valve from that regulating valve itself, and read out from a database characteristic information that is stored corresponding to this model number information and read it into the positioner, then it would reduce the time and effort for inputting the characteristic information of the regulating valve into the positioner, which is efficient from the perspective of the entire lifecycle. Moreover, the ability to reduce human error thereby was also contemplated.

Because of this, in the present invention a regulating valve model number information storage portion, which stores model number information of the regulating valve so as to be readable is provided in the regulating valve, and a regulating valve characteristic information database that stores characteristic information of each individual regulating valve, in relation to the model number of each individual regulating valve, are provided, where this regulating valve model number information that is stored in the regulating valve model number information storage portion is read out by a regulating valve model number information reading portion, the characteristic information corresponding to the model number that has been read out is acquired from the regulating valve characteristic information database by the regulating valve characteristic information acquiring portion, and the characteristic information of the regulating valve that has been acquired is converted into the required information by an information converting/setting portion and set in the positioner.

Note that, in the present invention, reading of the model number information of the regulating valve, which is stored in the regulating valve model number information storage portion, is performed by the regulating valve model number information reading portion, the acquisition of the regulating valve characteristic information corresponding to the regulating valve model number information that has been read out is performed by the regulating valve characteristic information acquiring portion, and the conversion of the regulating valve characteristic information that has been acquired into the required information, and setting it up in the positioner, is performed by the information converting/setting portion, but the regulating valve model number information reading portion, the regulating valve characteristic information acquiring portion, and the information converting/setting portion may instead be provided in the positioner, or, conversely, may be provided in a device other than the positioner (such as a mobile data reader, an instrument controlling system, or the like).

Moreover, in the present invention the regulating valve model number information reading portion may receive a command for starting reading, sent through a manual operation, to start reading out the regulating valve model number information that is stored in the regulating valve model number information storage portion. For example, when a positioner is installed in a regulating valve and the operator instructs that reading is to start, then reading of regulating valve model number information from the regulating valve model number information storage portion that is provided in the regulating valve is started. That is, upon a command from the operator to start reading, the regulating valve model number information is read out, the characteristic information corresponding to the model number that has been read out is acquired, the characteristic information that has been acquired is converted into the required information, and the converted required information is set up in the positioner, semiautomatically.

Moreover, the present invention may be provided with a regulating valve model number information read-enabled checking portion that checks whether or not the model number information of the regulating valve, which is stored in the regulating valve model number information storage portion can be read; wherein: reading of the model number information of the regulating valve, which is stored in the regulating valve model number information storage portion may begin upon confirmation, by the regulating valve model number information read-enabled checking portion, that the model number information can be read. Doing this enables reading of the model number information of the regulating valve, acquisition of the characteristic information of the regulator valve corresponding to the model number that has been read in, conversion, into the required information, of the characteristic information of the regulating valve that has been acquired, and setting up the converted required information in the positioner can all be performed fully automatically when the positioner is installed in the regulating valve.

Moreover, in the present invention, model number information of the regulating valve may be stored in a memory, and the stored model number information of the regulating valve may be read out through a communication line (read out through wired communication), or may be read out through wireless communication. Moreover, the model number information of the regulating valve may be stored so as to be readable optically from the outside, and the model number information that is stored may be read out optically without contact.

Moreover, in the present invention, the regulating valve model number information storage portion may be provided separately from a valve model number information storage portion that stores model number information of a valve, provided so as to be readable on the valve side, and from an actuator model number information storage portion that stores model number information of the actuator, stored so as to be readable on the actuator side. The regulating valve is structured from the valve and the actuator. While there are many different combinations of valves and actuators, having a valve model number information storage portion on the valve side and an actuator model number information storage portion on the actuator side makes it possible to read in the model number information of the valve from the valve side and read in the model number information of the actuator from the actuator side, thus providing the rich flexibility of being able to acquire the correct model number information of a regulating valve that is installed, regardless of the combination of the valve and the actuator, even if, during operations, the combination of the valve and the actuator is changed.

Moreover, in the present invention, the characteristic information of the regulating valve, acquired in by the regulating valve characteristic information acquiring portion, is converted into the required information and set up in the positioner. In this case, one may consider parameter values such as control parameters that are used in controlling the opening of the regulating valve, diagnostic parameters used in fault diagnostics in the regulating valve, as described in, for example, Japanese Unexamined Patent Application Publication No. 2004-21437 (“the JP '437”), and the like, as the converted required information. But there are also cases wherein characteristic information of the regulating valve that has been acquired, such as the opening diameter of the valve, is set up in the positioner as-is as a parameter value. The present invention includes, as “converted required information,” such regulating valve characteristic information that is set as-is, in the positioner.

Because, in the present invention, a regulating valve model number information storage portion, which stores model number information of the regulating valve so as to be readable is provided in the regulating valve, and a regulating valve characteristic information database that stores characteristic information of each individual regulating valve, in relation to the model number of each individual regulating valve, are provided, where this regulating valve model number information that is stored in the regulating valve model number information storage portion is read out by a regulating valve model number information reading portion, the characteristic information corresponding to the model number that has been read out is acquired from the regulating valve characteristic information database by the regulating valve characteristic information acquiring portion, and the characteristic information of the regulating valve that has been acquired is converted into the required information by an information converting/setting portion and set in the positioner, the time and effort for referencing the characteristic information of the regulating valve (manually checking the regulating valve, and manually reading the characteristic information of the regulating valve) can be eliminated, automating all or part of the operation for inputting the characteristic information of the regulating valve into the positioner, thus making it possible to reduce the time and effort in the operation for inputting the characteristic information of the regulating valve. Moreover, this can also reduce the possibility of human error, such as referencing the characteristic information of the wrong regulating valve or making an error when inputting the information, omitting information, or the like.

### BRIEF DESCRIPTIONS OF THE DRAWINGS

FIG. 1 is a diagram illustrating the critical portions in an example of a regulating valve opening controlling system according to the present invention.

FIG. 2 is a diagram illustrating an example (Specific Example 1) wherein model number information of a regulating valve is read out from a regulating valve model number information storage portion through a communication circuit (through wired communication).

FIG. 3 is a diagram illustrating an example (Specific Example 2) wherein model number information of a regulating valve is read out from a regulating valve model number information storage portion through wireless communication.

FIG. 4 is a diagram illustrating an example (Specific Example 3) wherein model number information of a regulating valve is read out optically from a regulating valve model number information storage portion.

FIG. 5 is a diagram illustrating an example wherein a mode checking function is provided in a positioner.

FIG. 6 is a diagram illustrating an example wherein model number information of valves and actuators are stored separately.

FIG. 7 is a diagram illustrating an example wherein a regulating valve model number information reading portion, a regulating valve characteristic information acquiring portion, and an information converting setting portion are provided in a mobile communicator.

FIG. 8 is a diagram illustrating an example wherein a regulating valve model number information reading portion, a regulating valve characteristic information acquiring portion, and an information converting setting portion are provided in an instrument controlling system.

FIG. 9 is a diagram for explaining an operation for inputting regulating valve characteristic information into a conventional positioner.

### DETAILED DESCRIPTION

The present invention will be explained in detail below based on the drawings.

FIG. 1 is a diagram illustrating the critical portions in an example of a regulating valve opening controlling system according to the present invention. In this figure, 1 is a regulating valve and 2 is a positioner that is equipped in the regulating valve 1, where the regulating valve opening controlling system 100 according to the present example is structured from the regulating valve 1 and the positioner 2.

In this regulating valve opening controlling system 100, the regulating valve 1 is provided with a valve 1-1 that opens and closes the passage through which a fluid flows, and an actuator 1-2 that receives a pneumatic pressure Pout, to drive the valve 1-1. Moreover, the regulating valve 1 is provided with a regulating valve model number information storage portion 1-3, as a distinctive structure in the present example, that readably stores the information of the regulating valve 1. A specific example of a regulating valve model number information storage portion 1-3 will be discussed below.

In this regulating valve opening controlling system 100, the positioner 2 is provided with a regulating valve model number information reading portion 2-2, a regulating valve characteristic information acquiring portion 2-3, and an information converting/setting portion 2-4, as distinctive structures in the present example, in addition to a valve controlling/calculating portion 2-1.

Moreover, a regulating valve characteristic information database 3 is provided for this regulating valve opening controlling system 100. The regulating valve characteristic information database 3 stores, for regulating valves 1 of a plurality of different model numbers, characteristic information of each individual regulating valve 1, in relation to the model number of each individual regulating valve 1. For example, as characteristic information of the regulating valve 1, the opening diameter of the valve, a valve opening diameter signal, a valve model number, a unique identifier for the regulating valve, and the like is stored as characteristic information of the regulating valve 1.

In the positioner 2, when the valve controlling/calculating portion 2-1 inputs an actual opening θpv of the valve 1-1 in the regulating valve 1, and a second opening θsp, from a higher-level device (not shown), to generate, and apply to the actuator 1-2 of the regulating valve 1, a pneumatic pressure Pout that depends on the difference between the actual opening θpv and the setting opening θsp. The opening of the valve 1-1 is controlled so that θpv will equal θsp.

In the positioner 2, a regulating valve model number information reading portion 2-2 receives a read start command that is sent from the outside, and starts reading out the model number information of the regulating valve 1, which is stored in the regulating valve model number information storage portion 1-3. For example, operating buttons are provided on the positioner 2, and when an operating button is pressed by an operator, the read start command is sent to the regulating valve model number information reading portion 2-2. Conversely, the read start command may be sent from a higher-level device as an operating command from the operator. When this read start command is received, the regulating valve model number information reading portion 2-2 accesses the regulating valve model number information storage portion 1-3, and begins reading the model number information of the regulating valve 1.

The model number information of the regulating valve 1 that has been read in by the regulating valve model number information reading portion 2-2 is sent to the regulating valve characteristic information acquiring portion 2-3. The regulating valve characteristic information acquiring portion 2-3 receives the model number information of the regulating valve 1 that has been sent from the regulating valve model number information reading portion 2-2, and acquires, from the regulating valve characteristic information database 3, the characteristic information of the regulating valve 1 corresponding to the model number information. The characteristic information of the regulating valve 1 that has been acquired is sent to the information converting/setting portion 2-4.

The information converting/setting portion 2-4 converts the characteristic information of the regulating valve 1 that has been sent from the regulating valve characteristic information acquiring portion 2-3, that is, the characteristic information of the regulating valve 1 that has been acquired by the regulating valve characteristic information acquiring portion 2-3, into parameter values corresponding to the characteristic information, and sets them in a valve controlling/calculating portion 2-1.

In the present example, the information converting/setting portion 2-4 stores various types of parameter information such as, for example, control parameters that are used in controlling the opening of the valve, such as the proportional gain, the integrating time, the differentiating time, and the like. The information converting/setting portion 2-4 reads out parameter values, depending on the characteristic information, from the characteristic information of the regulating valve 1 that have been acquired by the regulating valve characteristic information acquiring portion 2-3, and sets them in the valve controlling/calculating portion 2-1.

Note that in this characteristic information of the regulating valve 1, acquired by the regulating valve characteristic information acquiring portion 2-3, the opening diameter of the valve, etc., are set in the valve controlling/calculating portion 2-1 as-is, as the parameter values of the characteristic information that have been read in. Moreover, if the positioner 2 is provided with a regulating valve fault diagnostics function where information pertaining to fault diagnostics of the regulating valve are included in the characteristic information of the regulating valve 1 that is acquired by the regulating valve characteristic information acquiring portion 2-3, then this information is converted into diagnostic parameters used in the fault diagnostics for the regulating valve, and the converted diagnostic parameter values are set up in a fault diagnostics function portion (not shown). Note that the valve controlling/calculating portion 2-1 is not limited to a fault diagnostics functioning portion (not shown), but, of course, this may be applied also if the target for setting the parameter values is a memory able to store parameters.

In this way, in the regulating valve opening controlling system 100 according to the present example, when a positioner 2 is installed in a regulating valve 1, by merely sending a read start command, through a manual operation, to the regulating valve model number information reading portion 2-2 of the positioner 2, the model number information of the regulating valve 1 is read in from the regulating valve model number information storage portion 1-3, characteristic information corresponding to the model number information that has been read in is acquired, the characteristic information that has been acquired is converted into parameter values, and the converted parameter values are set.

As a result, in the regulating valve opening controlling system 100 according to the present example, the time and effort for referencing the characteristic information of the regulating valve 1 (manually checking the regulating valve 1, and manually reading the characteristic information of the regulating valve 1) can be eliminated, automating a portion of the operation for inputting the characteristic information of the regulating valve 1 into the positioner 2, thus making it possible to reduce the time and effort in the operation for inputting the characteristic information of the regulating valve 1. Moreover, this can also reduce the possibility of human error, such as referencing the characteristic information of the wrong regulating valve or making an error when inputting the information, omitting information, or the like.

FIG. 2 illustrates a specific example (Specific Example 1) of a system for reading model number information of a regulating valve 1 from the regulating valve model number information storage portion 1-3. In the Specific Example 1, the regulating valve model number information storage portion 1-3 is a memory, where the model number information of the regulating valve 1 is stored in this memory. Furthermore, a communication line is provided between the regulating valve model number information storage portion 1-3 of the regulating valve 1 and the regulating valve model number information reading portion 2-2 of the positioner 2, where the model number information of the regulating valve 1, which is stored in the regulating valve model number information storage portion 1-3 (the memory) is read out through this communication line. That is, the model number information of the regulating valve 1 is read out through wired communication.

FIG. 3 illustrates another specific example (Specific Example 2) of a system for reading model number information of a regulating valve 1 from the regulating valve model number information storage portion 1-3. In this Specific Example 2, the regulating valve model number information storage portion 1-3 is an RFID (Radio Frequency ID) tag, where the model number information of the regulating valve 1 is stored in the RFID tag. Note that an RFID tag is also a type of memory as referenced in the present invention. Given this, an RFID reader is used as the regulating valve model number information reading portion 2-2 in the positioner 2, where the model number information of the regulating valve 1, which is stored in the regulating valve model number information storage portion 1-3 (the RFID tag) is read out through wireless communication between the RFID tag and the RFID reader. That is, the model number information of the regulating valve 1 is read out through wireless communication.

FIG. 4 illustrates yet another specific example (Specific Example 3) of a system for reading model number information of a regulating valve 1 from the regulating valve model number information storage portion 1-3. In this Specific Example 3, a sticker whereon a barcode is printed is used as the regulating valve model number information storage portion 1-3, where the model number information of the regulating valve 1 is stored as a barcode on the sticker. This sticker is adhered to an outside surface, for example, of the regulating valve 1. Given this, a camera is used as the regulating valve model number information reading portion 2-2 of the positioner 2, and an image of the barcode that is printed on the sticker is captured by the camera, to read out, optically, without contact, the model number information of the regulating valve 1, which is stored in the regulating valve model number information storage portion 1-3 (the sticker).

Note that while in the Specific Example 3, illustrated in FIG. 4, a barcode was used to enable the model number information of the regulating valve 1 to be read out optically from the outside, there is no limitation to a barcode, of course. For example, a QR Code™ may be used instead of a barcode.

Moreover, while in the example set forth above, the structure may be one wherein a read start command was sent through a manual operation to the regulating valve model number information reading portion 2-2 of the positioner 2, when, for example, the positioner 2 is installed in the regulating valve 1, the regulating valve model number information storage portion 1-3 of the regulating valve 1 may go into a read-out mode for a specific time interval, that is, a mode wherein the model number information of the regulating valve 1, which is stored, can be read out, where the positioner 2 checks whether or not this mode wherein reading is possible has been entered, to start the operation of the regulating valve model number information reading portion 2-2. In this case, the regulating valve model number information storage portion 1-3 of the regulating valve 1 goes into a sleep mode after a specific amount of time has elapsed.

FIG. 5 shows an example of the provision of a mode checking function in the positioner 2. In this example, if a positioner 2 is installed, the regulating valve 1 has a function wherein it goes into a mode wherein the regulating valve 1 regulating valve model number information storage portion 1-3 can be read over a specific time interval, and then after that specific time interval has elapsed, goes into a sleep mode. Assuming that the installation is into a regulating valve 1 that has such a function, the positioner 2, in the example illustrated in FIG. 5, is provided with a mode checking portion 2-5 that checks whether or not the regulating valve model number information storage portion 1-3 of the regulating valve 1 is in a mode wherein reading is enabled.

When, in the positioner 2, the mode checking portion 2-5 confirms that the regulating valve model number information storage portion 1-3 of the regulating valve 1 is in the reading-enabled mode, it sends a read start command to the regulating valve model number information reading portion 2-2. Upon receipt of this read start command, the regulating valve model number information reading portion 2-2 accesses the regulating valve model number information storage portion 1-3, to start reading out the model number information of the regulating valve 1, which is stored in the regulating valve model number information storage portion 1-3. As a result, when the positioner 2 is installed in the regulating valve 1, in the positioner 2 the model number information is read out from the regulating valve 1, characteristic information corresponding to the model number information that has been read out is acquired, the acquired characteristic information is converted into parameter values, and the converted parameter values are set, all fully automatically.

Moreover, while in the example set forth above the model number information of the regulating valve 1 was stored in a single regulating valve model number information storage portion 1-3, instead the model number information may be stored separately for the valve 1-1 and the actuator 1-2. FIG. 6 shows one example of this.

In the example illustrated in FIG. 6, a valve model number information storage portion 1-31 that stores model number information of the valve 1-1 is provided on the valve 1-1 side, and an actuator model number information storage portion 1-32, which stores the model number information of the actuator 1-2, is provided on the actuator 1-2 side.

In this case, when the regulating valve model number information reading portion 2-2 of the positioner 2 receives a read start command, the model number information of the valve 1-1 is read out from the valve model number information storage portion 1-31 and the model number information of the actuator 1-2 is read out from the actuator model number information storage portion 1-32, and the model number information that has been read out for the valve 1-1 and the actuator 1-2 is combined and sent to the regulating valve characteristic information acquiring portion 2-3 as the model number information of the regulating valve 1.

While, in the regulating valve 1, there can be many different combinations of valves 1-1 and actuators 1-2, storing respectively in the valve model number information storage portion 1-31 on the valve 1-1 side and in the actuator model number information storage portion 1-32 on the actuator 1-2 side, enables the model number information of the valve 1-1 to be read in from the valve 1-1 side and the model number information of the actuator 1-2 to be read in from the actuator 1-2 side, so that regardless of the combination of the valve 1-1 and the actuator 1-2, and even if the combination of the valve 1-1 and the actuator 1-2 were to be changed, it is still possible to obtain the correct model number information of the regulating valve 1 but is installed, providing rich flexibility.

Moreover, while, in the example set forth above, the regulating valve model number information reading portion 2-2, the regulating valve characteristic information acquiring portion 2-3, and the information converting/setting portion 2-4 were provided in the positioner 2 as structures that are distinctive to the present example, these structures may be provided in a device other than the positioner 2

For example, a regulating valve model number information reading portion 4-1, a regulating valve characteristic information acquiring portion 4-2, and an information converting/setting portion 4-3, corresponding to the a regulating valve model number information reading portion 2-2, a regulating valve characteristic information acquiring portion 2-3, and an information converting/setting portion 2-4, may be provided in a mobile data reader 4, as illustrated in FIG. 7, and the mobile data reader 4 may be connected between the regulating valve 1 and the positioner 2.

Moreover, a regulating valve model number information reading portion 5-1, a regulating valve characteristic information acquiring portion 5-2, and an information converting/setting portion 5-3, corresponding to the a regulating valve model number information reading portion 2-2, a regulating valve characteristic information acquiring portion 2-3, and an information converting/setting portion 2-4, may be provided in an instrument controlling system 5, as illustrated in FIG. 8, and the instrument controlling system 5 may be connected between the regulating valve 1 and the positioner 2.

In this case, the reading of model number information of the regulating valve 1 by the mobile data reader 4 or the instrument controlling system 5 may be through a system such as serial signals, wireless signals, a two-dimensional image (a barcode or QR code), or the like. Moreover, the transmission of parameter values from the mobile data reader 4 or the instrument controlling system 5 to the positioner 2 may be through a serial signal, a Fieldbus signal, an Ethernet™ signal, or the like.

Note that, in FIG. 7, the regulating valve model number information reading portion 4-1 may be separated from the mobile data reader 4, or provided as an independent device, or the like. Moreover, the system may be such that the mobile data reader 4 is connected between the regulating valve 1 and the positioner 2 only when in use, or may be such that it is always connected. Moreover, the regulating valve characteristic information database 3 may instead be provided in the mobile data reader 4, or in the positioner 2. It may also be as in the system illustrated in FIG. 8.

### EXTENDED EXAMPLES

While the present invention has been explained above in reference to the example, the present invention is not limited to the example set forth above. The structures and details in the present invention may be varied in a variety of ways, as can be understood by one skilled in the art, within the scope of technology in the present invention.

1. A regulating valve opening controlling system comprising:
a regulating valve having a valve wherein a passage through which a fluid flows is opened and closed and an actuator that receives a pneumatic pressure and drives the valve;
a positioner, provided with the regulating valve, which controls the opening of the valve by applying, to the actuator, a pneumatic pressure that depends on a difference between the actual opening of the valve and an opening setting;
a regulating valve characteristic information database that stores, for regulating valves of a plurality of different model numbers, characteristic information of each individual regulating valve, in relation to the model number of each individual regulating valve;
a regulating valve model number information storage portion that stores model number information of the regulating valve, provided readably in the regulating valve;
a regulating valve model number information reading portion that reads the model number information of the regulating valve, which is stored in the regulating valve model number information storage portion;
a regulating valve characteristic information acquiring portion that acquires, from the regulating valve characteristic information database, characteristic information corresponding to the model number information of the regulating valve, which has been read out by the regulating valve model number information reading portion; and
an information converting/setting portion that converts into specific information, and sets in the positioner, characteristic information of the regulating valve, which has been acquired by the regulating valve characteristic information acquiring portion.

2. The regulating valve opening controlling system as set forth in claim 1, wherein:
the regulating valve model number information reading portion, the regulating valve characteristic information acquiring portion, and information converting/setting portion are provided in the positioner.

3. The regulating valve opening controlling system as set forth in claim 1, wherein:
the regulating valve model number information reading portion, the regulating valve characteristic information acquiring portion, and information converting/setting portion are provided in a device other than the positioner.

4. The regulating valve opening controlling system as set forth in claim 1, wherein:
the regulating valve model number information reading portion receives a read start command that is sent through a manual operation, to start reading the model number information of the regulating valve, which is stored in the regulating valve model number information storage portion.

5. The regulating valve opening controlling system as set forth in claim 1, comprising:
a regulating valve model number information read-enabled checking portion that checks whether or not the model number information of the regulating valve, which is stored in the regulating valve model number information storage portion, is readable; wherein:
the regulating valve model number information reading portion begins reading the model number information of the regulating valve, which is stored in the regulating valve model number information storage portion upon confirmation, by the regulating valve model number information read-enabled checking portion, that the model number information, is readable.

6. The regulating valve opening controlling system as set forth in claim 1, wherein:
the regulating valve model number information storage portion stores the regulating valve model number information in a memory; and
the regulating valve model number information reading portion reads out the model number information of the regulating valve through a communication line that is connected between the regulating valve model number information storage portion and the regulating valve model number information reading portion.

7. The regulating valve opening controlling system as set forth in claim 1, wherein:
the regulating valve model number information storage portion stores the regulating valve model number information in a memory; and
the regulating valve model number information reading portion reads out the model number information of the regulating valve through wireless communication between the regulating valve model number information storage portion and the regulating valve model number information reading portion.

8. The regulating valve opening controlling system as set forth in claim 1, wherein:
the regulating valve model number information storage portion stores the model number information of the regulating valve so as to be optically readable from the outside; and
the regulating valve model number information acquiring portion acquires the model number information of the regulating valve optically, without contact.

9. The regulating valve opening controlling system as set forth in claim 1, wherein:
the regulating valve model number information storage portion comprises:
a valve model number information storage portion that is equipped readably on the valve side, and stores model number information of the valve; and
an actuator model number information storage portion that is equipped readably on the actuator side, and stores model number information of the actuator.

10. The regulating valve opening controlling system as set forth in claim 1, wherein:
the information converting/setting portion converts into a control parameter that is used in controlling the opening of the regulating valve, or into a diagnostics parameter that is used in fault diagnostics of the regulating valve, and sets up in the positioner, the characteristic information of the regulating valve, acquired by the regulating valve characteristic information acquiring portion.
